(19) United States
(12) Patent Application Publication
(10) Pub. No.: US 2025/0318461 A1
(43) Pub. Date: Oct. 16, 2025

(54) AGRICULTURAL SYSTEM AND METHOD FOR CONTROLLING BASE CUTTER OPERATION FOR A HARVESTER

(71) Applicant: CNH Industrial Brasil Ltda., Nova Lima (BR)

(72) Inventor: Joao Augusto Marcolin Lucca, Piracicaba-SP (BR)

(21) Appl. No.: 19/176,551

(22) Filed: Apr. 11, 2025

(30) Foreign Application Priority Data
Apr. 12, 2024 (BR) 10 2024 007187 5

(51) Int. Cl. A01D 34/00; A01D 34/74; A01D 45/10

(52) U.S. Cl. CPC A01D 34/008; A01D 34/74; A01D 45/10

(57) ABSTRACT

An agricultural system for controlling base cutter operation for an agricultural harvester includes a first base cutter assembly having a first inner disc and a first outer disc. The system also includes a second base cutter assembly having a second inner disc and a second outer disc. The first and second base cutter assemblies are movable relative to each other in a vertical direction. Additionally, the first and second inner discs are positioned relative to each other such that a plurality of blades of the first inner disc circumferentially overlap with a plurality of blades of the second inner disc when the first and second inner discs are disposed at a common vertical position. Moreover, the system includes a computing system configured to control an operation of the first and second base cutter assemblies to prevent contact between the blades of the first and second inner discs.

### FIELD OF THE INVENTION

The present disclosure relates generally to agricultural harvesters and, more particularly, to agricultural systems and methods for controlling the operation of base cutter assemblies of a harvester during a harvesting operation to prevent contact between adjacent cutter discs of the base cutter assemblies.

### BACKGROUND OF THE INVENTION

Typically, agricultural harvesters include an assembly of processing equipment for processing harvested crop materials. For instance, a sugarcane harvester typically includes a base cutter assembly having a pair of cutter discs configured to sever sugarcane stalks. The severed sugarcane stalks are then conveyed via a feed roller assembly to a chopper assembly that cuts or chops the sugarcane stalks into pieces or billets (e.g., 6 inch cane sections). The processed crop material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

For sugarcane harvesters configured for multi-row harvesting, the harvester will include two or more base cutter assemblies depending on the number of rows being simultaneously harvested. For instance, for a dual-row harvesting configuration, two base cutter assemblies are positioned at the front-end of the harvester, with each assembly including a pair of cutter discs for severing the sugarcane stalks of its respective crop row. In general, the lateral spacing between adjacent base cutter assemblies is set based on the row spacing between crop rows. For larger or wider row spacings, a lateral gap typically exists between the inner discs of the adjacent base cutter assemblies such that no interference or contact will occur between such inner discs. However, for smaller or narrower row spacings, it is possible that the first and second base cutter assemblies must be shifted closer together in the lateral direction such that the cutter blades of the inner discs of the two separate base cutter assemblies circumferentially overlap each other when the blades are at the same vertical height. In such instance, a significant risk exists for contact between the cutter blades of the adjacent inner discs as the base cutter assemblies move relative to each other in the vertical direction, which can lead to damage to the base cutter assemblies.

Accordingly, an improved agricultural system and method for controlling the operation of base cutter assemblies of a harvester to prevent contact between adjacent cutter discs would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for controlling base cutter operation for an agricultural harvester. The agricultural system includes a first base cutter assembly comprising a first pair of cutter discs. The first pair of cutter discs includes a first inner disc and a first outer disc, with each of the first inner and outer discs including a plurality of blades spaced apart circumferentially around its outer perimeter. The system also includes a second base cutter assembly comprising a second pair of cutter discs. The second pair of cutter discs includes a second inner disc and a second outer disc, with each of the second inner and outer discs including a plurality of blades spaced apart circumferentially around its outer perimeter. The first and second base cutter assemblies are movable relative to each other in a vertical direction. Additionally, the first and second inner discs are positioned relative to each other in a lateral direction such that the plurality of blades of the first inner disc circumferentially overlap with the plurality of blades of the second inner disc when the first and second inner discs are disposed at a common vertical position. Moreover, the system includes a computing system configured to control an operation of the first and second base cutter assemblies to prevent contact between the plurality of blades of the first inner disc and the plurality of blades of the second inner disc as the first and second base cutter assembles are moved relative to each other in the vertical direction.

In another aspect, the present subject matter is directed to an agricultural method for controlling base cutter operation for an agricultural harvester, with the agricultural harvester including a first base cutter assembly and a second base cutter assembly. The method includes monitoring, with a computing system, a first vertical position of the first base cutter assembly and a second vertical position of the second base cutter assembly, wherein the first base cutter assembly comprises a pair of cutter discs including a first inner disc and a first outer disc, and the second base cutter assembly comprises a second pair of cutter discs including a second inner disc and a second outer disc. The method also includes comparing, with the computing system, a vertical offset between the first and second vertical positions to a vertical offset threshold selected for the first and second base cutter assemblies. Additionally, when the vertical offset drops below the vertical offset threshold, the method includes controlling, with the computing system, an operation of at least one of the first base cutter assembly or the second base cutter assembly to prevent contact between a plurality of blades of the first inner disc of the first base cutter assembly and a plurality of blades of the second inner disc of the second base cutter assembly. The first and second inner discs are positioned relative to each other in a lateral direction such that plurality of blades of the first inner disc circumferentially overlap with the plurality of blades of the second inner disc when the first and second inner discs are disposed at a common vertical position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a bottom view of portions of a front end of an agricultural harvester, particularly illustrating the relative positioning of first and second base cutter assemblies to crop dividers of the harvester in accordance with aspects of the present subject matter;

FIG. 3 illustrates a top, perspective view of the base cutter assemblies shown in FIG. 2 in accordance with aspects of the present subject matter;

FIG. 4 illustrates a schematic view of one embodiment of a system for controlling base cutter operation for an agricultural harvester in accordance with aspects of the present subject matter;

FIG. 5 illustrates a flow diagram of one embodiment of control logic that may be implemented for controlling base cutter operation in accordance with aspects of the present subject matter; and

FIG. 6 illustrates a flow diagram of one embodiment of a method for controlling base cutter operation for an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and methods for controlling base cutter operation for an agricultural harvester, such as a sugarcane harvester. More particularly, the disclosed systems and methods may be used to control the operation of base cutter assemblies in instances in which a cutter disc (e.g., an inner cutter disc) of one base cutter assembly is positioned relative to a cutter disc (e.g., an inner cutter disc) of an adjacent base cutter assembly such that the blades of such cutter discs are configured to circumferentially overlap one another when the blades are at the same height. In such instances, the operation of the base cutter assemblies may be automatically controlled in a manner that prevents or substantially reduces the likelihood that the blades of the adjacent cutter discs contact or interfere with one another during operation of the base cutter assemblies.

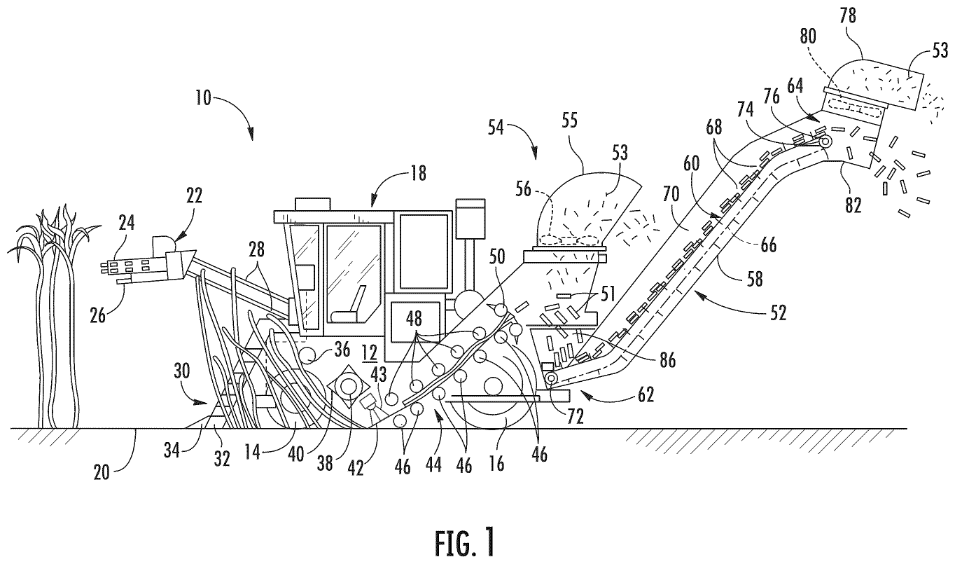

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging sugarcane as the cane is harvested from an agricultural field 20. For instance, during operation, the harvester 10 is traversed across an agricultural field 20 for harvesting crop, such as sugarcane. The harvester 10 may include a topper assembly 22 positioned at its front end to intercept sugarcane as the harvester 10 is moved in the forward direction. As shown, the topper assembly 22 may include both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 may be adjustable via a pair of arms 28 hydraulically raised and lowered, as desired, by the operator. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10.

The harvester 10 may further include one or more crop dividers 30 that extends upwardly and rearwardly from the field 20. In general, each crop divider 30 may include one or more spiral feed rollers 32, such as two spiral feed rollers 32. Each feed roller 32 may include a ground shoe 34 at its lower end to assist the crop divider 30 in gathering the sugarcane stalks for harvesting. As the stalks approach a crop divider 30, the ground shoes 34 may set the operating width to determine the quantity of sugarcane entering the throat of the harvester 10. The spiral feed rollers 32 then gather the stalks into a throat to allow a knock-down roller 36 to bend the stalks downwardly in conjunction with the action of a fin roller 38. The knock-down roller 36 is positioned near the front wheels 14 and the fin roller 38 positioned behind or downstream of the knock-down roller 36. As the knock-down roller 36 is rotated, the sugarcane stalks being harvested are knocked down. The fin roller 38 may include a plurality of intermittently mounted fins 40 that assist in forcing the sugarcane stalks downwardly. For instance, as the fin roller 38 is rotated, the sugarcane stalks that have been knocked down by the knock-down roller 36 are separated and further knocked down by the fin roller 38 as the harvester 10 continues to be moved in the forward direction relative to the field 20.

Once the stalks are angled downwardly as shown in FIG. 1, a base cutter assembly 42 may then sever the base of the stalks from field 20. The base cutter assembly 42 is positioned behind or downstream of the fin roller 38. As is generally understood, the base cutter assembly 42 may include a pair of cutter discs 43 for severing the sugarcane stalks as the cane is being harvested. The cutter discs 43 may be rotationally driven by a motor (not shown), such as a hydraulic motor powered by the vehicle's hydraulic system or an electric motor. Moreover, in several embodiments, the cutter discs 43 may be angled downwardly to sever the base of the sugarcane as the cane is knocked down by the fin roller 38. Additionally, the height of each base cutter assembly 42 (e.g., the height of the cutter discs 43) above the field 20 may be adjustable. For instance, it may be preferable to sever the sugarcane stalks at or below a particular cutting height above the field 20 such that the maximum amount of sugarcane is harvested during the current harvesting operation and such that the remaining ratoons may regrow during the next growing season. As such, the vertical height of the base cutter assembly 42 may be adjustable to maintain the cutting height for harvesting the sugarcane at or below the particular cutting height.

The severed stalks are then, by movement of the harvester 10, directed to a feed roller assembly 44 located downstream of the base cutter 42 for moving the severed stalks of sugarcane from base cutter 42 along the processing path. As shown in FIG. 1, the feed roller assembly 44 may include a plurality of bottom rollers 46 and a plurality of opposed, top pinch rollers 48. The harvested sugarcane may be pinched between various bottom and top rollers 46, 48 to make the sugarcane stalks more uniform and to convey the harvested sugarcane rearwardly (downstream) during transport. As the sugarcane is transported through the feed roller assembly 44, debris (e.g., rocks, dirt, and/or the like) may be allowed to fall through bottom rollers 46 onto the field 20.

At the downstream end of the feed roller assembly 44 (e.g., adjacent to the rearward-most bottom and top rollers 46, 48), a chopper assembly 50 may cut or chop the compressed sugarcane stalks. In general, the chopper assembly 50 may be used to cut the sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, a primary extractor assembly 54 may be provided to help separate pieces of debris 53 (e.g., dust, dirt, leaves, etc.) from the sugarcane billets 51 before the billets 51 are received by the elevator assembly 52. The primary extractor assembly 54 is located immediately behind or downstream of the chopper assembly 50 relative to the flow of harvested crop and is oriented to direct the debris 53 outwardly from the harvester 10. The primary extractor assembly 54 may include an extractor fan 56 mounted within a housing 55 for generating a suction force or vacuum sufficient to separate and force the debris 53 through an inlet of the housing 55 into the primary extractor assembly 54 and out of the harvester 10 via an outlet of the housing 55. The separated or cleaned billets 51 are heavier than the debris 53 being expelled through the extractor 54, so the billets 51 may fall downward to the elevator assembly 52 instead of being pulled through the primary extractor assembly 54.

As further shown in FIG. 1, the elevator assembly 52 may include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Additionally, in some embodiments, pieces of debris or trash 53 (e.g., dust, dirt, leaves, etc.) separated from the elevated sugarcane billets 51 may be expelled from the harvester 10 through a secondary extractor assembly 78 coupled to the rear end of the elevator housing 58. For example, the debris 53 expelled by the secondary extractor assembly 78 may be debris remaining after the billets 51 are cleaned and debris 53 expelled by the primary extractor assembly 54. As shown in FIG. 1, the secondary extractor assembly 78 may be located adjacent to the distal end 64 of the elevator 60 and may be oriented to direct the debris 53 outwardly from the harvester 10. Additionally, an extractor fan 80 may be mounted at the base of the secondary extractor assembly 78 for generating a suction force or vacuum sufficient to pick up the debris 53 and force the debris 53 through the secondary extractor assembly 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

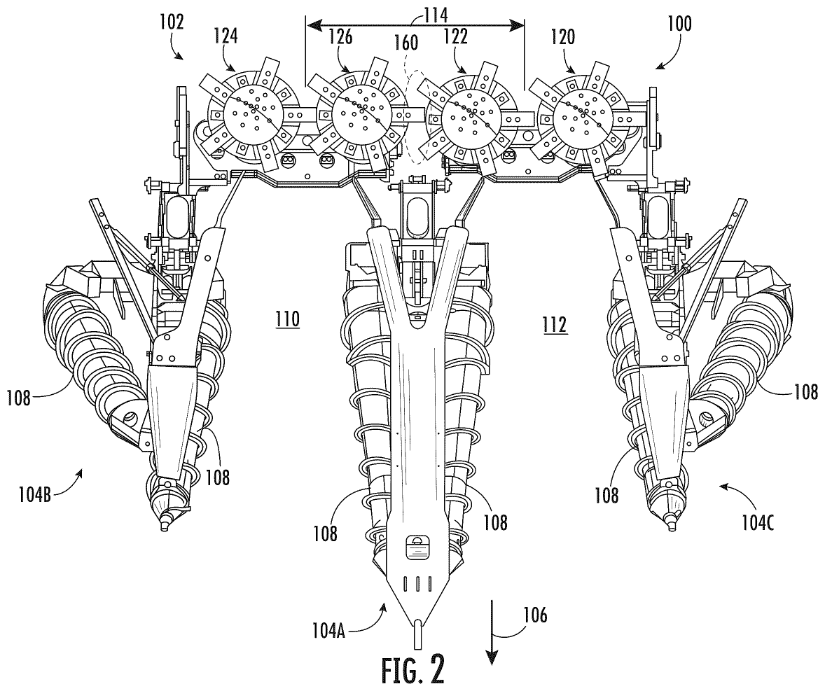

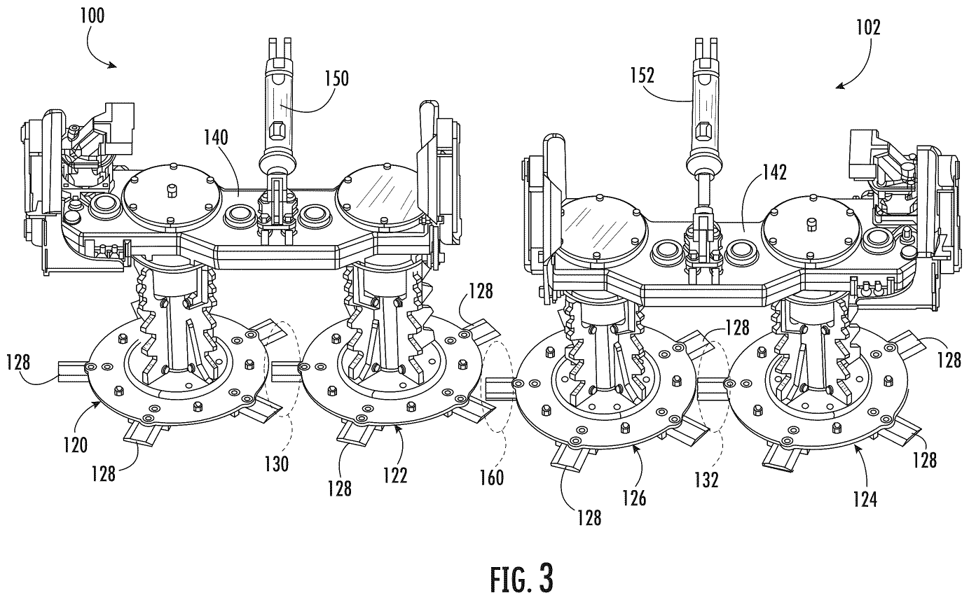

Referring now to FIGS. 2 and 3, different views of one embodiment of base cutter assemblies 100, 102 suitable for use with an agricultural harvester are illustrated in accordance with aspects of the present subject matter. Specifically, FIG. 2 illustrates a bottom view of portions of a front end of an agricultural harvester, particularly illustrating the relative positioning of the base cutter assemblies 100, 102 to crop dividers 104 of the harvester. Additionally, FIG. 3 illustrates a top, perspective view of the base cutter assemblies 100, 102 shown in FIG. 2. It should be appreciated that the base cutter assemblies 100, 102 shown and described with reference to FIGS. 2 and 3 may, for example, be utilized in association with the harvester 10 described above with reference to FIG. 1 (e.g., as base cutter assemblies 42) and/or any other suitable agricultural harvester having any suitable harvesting configuration.

As particularly shown in FIG. 2, the front end of the harvester is shown as being configured for dual-row or double-row harvesting and, thus, includes first and second base cutter assemblies 100, 102 positioned aft or downstream of a plurality of crop dividers 104 relative to a forward direction of travel of the harvester (e.g., as indicated by arrow 106 in FIG. 2). Specifically, in the illustrated embodiment, a set of three crop dividers 104 are provided at the front end of the harvester, namely a central or inner crop divider 104A and first and second outer crop dividers 104B, 104C. As shown in FIG. 2, each crop divider 104 includes one or more spiral feed rollers 108 configured to gather stalks into a downstream throat for further processing (e.g., to allow the stalks to be bent downwardly via a downstream knock-down roller (not shown)). For instance, the first outer crop divider 104B and the inner crop divider 104A may function to gather stalks of a first row of crops into a first throat region 110 defined between such respective dividers 104B, 104A, while the second outer crop divider 104C and the inner crop divider 104A may function to gather stalks of a second row of crops into a second throat region 112 defined between such respective dividers 104C, 104A.

As shown in FIG. 2, the base cutter assemblies 100, 102 are positioned downstream or aft of the crop dividers 104 relative to the forward direction of travel 106 of the harvester such that the base cutter assemblies 100, 102 can function to cut or sever the base of each stalk of the respective crop rows gathered into the throat regions 110, 112 to allow such stalks to be harvested and further processed by the harvester. In this regard, a lateral spacing 114 defined between the base cutter assemblies 100, 102 in a lateral direction of the harvester (e.g., as indicated by arrow L in FIG. 2) may generally be selected based on the row spacing defined between the crop rows being harvested. For instance, the lateral spacing 114 may be selected such that each crop row is aligned with a center of the respective base cutter assembly 100, 102.

As particularly shown in FIG. 3, each base cutter assembly 100, 102 may generally include a pair of cutter discs. Specifically, the first base cutter assembly 100 includes a first outer disc 120 and a first inner disc 122 and the second base cutter assembly 102 includes a second outer disc 124 and a second inner disc 126. As shown in FIG. 3, each cutter disc 120, 122, 124, 126 includes a plurality of cutter blades 128 spaced circumferentially apart from one another around the outer perimeter of the blade. These cutter blades 128 generally function as the cutting means for severing the stalks from each row. In this regard, the inner and outer discs 120, 122, 124, 126 of each base cutter assembly 100, 102 may generally be configured to be positioned relative to each other in the lateral direction L such that the blades 128 of the respective discs circumferentially overlap one another within a cutting zone defined between the discs. Specifically, as shown in FIG. 3, a first cutting zone (indicated generally by the area within the dashed oval 130 in FIG. 3) may be defined between the inner and outer discs 122, 120 of the first base cutter assembly 100 across which the blades 128 of the inner and outer discs 122, 120 circumferentially overlap as the discs 122, 120 are rotated relative to each other (e.g., in counter-rotating directions). Similarly, a second cutting zone (indicated generally by the area within the dashed oval 132 in FIG. 3) may be defined between the inner and outer discs 126, 124 of the second base cutter assembly 102 across which the blades 128 of the inner and outer discs 126, 124 circumferentially overlap as the discs 126, 124 are rotated relative to each other (e.g., in counter-rotating directions).

As will be described below, to prevent contact or interference between the blades 128 of the inner and outer discs 120, 122, 124, 126 of the respective base cutter assemblies 100, 102, the rotation of the discs may be mechanically synchronized via a gearbox in order to maintain a given circumferential offset between the blades of the inner and outer discs as they sequentially pass through their respective cutting zones 130, 132. For instance, the first base cutter assembly 100 may include a first gearbox 140 incorporating suitable gearing or a geartrain that mechanically synchronizes the rotation of the first inner and outer discs 120, 122, thereby ensuring that a suitable circumferential offset is maintained between the blades 128 of such discs 120, 122. Similarly, the second base cutter assembly 102 may include a second gearbox 142 incorporating suitable gearing or a geartrain that mechanically synchronizes the rotation of the second inner and outer discs 124, 126, thereby ensuring that a suitable circumferential offset is maintained between the blades 128 of such discs 124, 126.

Referring still to FIG. 3, each base cutter assembly 100, 102 may also include an actuator configured to allow for the vertical positioning of such base cutter assembly to be adjusted. For instance, as shown in the illustrated embodiment, the first base cutter assembly 100 includes a first actuator 150 coupled to a portion of such assembly 100 (e.g., an outer housing of the first gearbox 140) to allow the actuator 150 to raise and lower the first base cutter assembly 100 relative to the ground, thereby adjusting the vertical positioning of the first inner and outer discs 120, 122 relative to the ground to ensure a proper cutting height for the stalks. Similarly, the second base cutter assembly 102 includes a second actuator 152 coupled to a portion of such assembly 102 (e.g., an outer housing of the second gearbox 142) to allow the actuator 152 to raise and lower the second base cutter assembly 102 relative to the ground, thereby adjusting the vertical positioning of the second inner and outer discs 124, 126 relative to the ground to ensure a proper cutting height for the stalks. In several embodiments, the actuators 150, 152 may be configured to operate in both a float mode and an active control mode. In the float mode, each actuator 150, 152 may function to allows its respective base cutter assembly 100, 102 to follow the profile of the ground such that the base cutter assembly 100, 102 rises and falls with respective changes in the profile of the ground surface. In the active control mode, the operation of each actuator 150, 152 may be controlled to raise or lower the base cutter assemblies 100, 102 to a given vertical position and/or to implement aspects of the base cutter control methodology described herein.

It should be appreciated that, in the illustrated embodiment, the end of each actuator 150, 152 opposite the end coupled to the respective base cutter assembly 100, 102 may generally be coupled to any suitable component(s) of the harvester that allows the actuators 150, 152 to function as described herein. For instance, in one embodiment, such ends of the actuators 150, 152 may be coupled to a portion of a frame that supports the base cutter assemblies 100, 102 relative to the remainder of the harvester.

As shown in both FIG. 2 and FIG. 3, due to the selected lateral spacing 114 (FIG. 2) between the first and second base cutter assemblies 100, 102, the blades 128 of the first and second inner discs 122, 126 are configured to circumferentially overlap one another when the discs 122, 125 are at the same vertical height (also referred to herein as a “common vertical position”) across a circumferential overlap zone defined between the inner discs 122, 126 (the zone being generally indicated by the area within the dashed ovals 160 in FIGS. 2 and 3). As a result, there is an increased likelihood of contact between the blades 128 of the inner discs 122, 126 when the discs 122, 126 are operating at the same vertical height and/or when such discs 122, 126 are moved past or across each other with relative vertical motion between the base cutter assemblies 100, 102. For instance, when operating in the float mode, the first inner and outer discs 120, 122 may be initially operating at a lower vertical position than the second inner and outer discs 124, 126 due to the first base cutter assembly 100 being moved across a portion of the field having a lower vertical profile than the vertical profile being experienced by the second base cutter assembly 102. However, if the profile of the field switches such that the discs 120, 122 of the first base cutter assembly 100 need to shift upwardly and/or the discs 124, 126 of the second base cutter assembly 102 need to shift downwardly, the inner discs 122, 126 of the base cutter assemblies 100, 102 may need to be moved vertically across each other, in which case the blades 128 of such discs 122, 126 may potentially contact as they rotate through the circumferential overlap zone 160. As will be described below, the presently disclosed systems and methods allow for the operation of the base cutter assemblies 100, 102 to be automatically controlled in a manner that prevents contact or interference of the blades 128 of the inner discs 122, 126 as the base cutter assemblies 100, 102 move relative to each other in the vertical direction.

It should be appreciated that, for purposes of description, the base cutter assemblies 100, 102 have been described with reference to a dual-row or double-row harvesting configuration. In other embodiments, the associated harvester may have any other suitable multi-row harvesting configuration, such as a three-row harvesting configuration or a four-row harvesting configuration. In such embodiments, it should be appreciated that the harvester may include a corresponding number of base cutter assemblies in association with the desired harvesting configuration. For instance, with a three-row harvesting configuration, the harvester may include three base cutter assemblies, in which case a circumferential overlap zone may be defined between the adjacent discs of each adjacent pair of base cutter assemblies, depending, of course, on the crop row spacing and the associated lateral spacing between the base cutter assemblies.

It should also be appreciated that the harvester components described above with reference to FIGS. 2 and 3 may be installed or mounted on the main frame or chassis of a harvester or may be installed or mounted on a separate header that is supported by the harvester at its front end. In this regard, the presently disclosed systems and methods may be utilized regardless of whether the base cutter assemblies are frame/chassis-mounted or header-mounted assemblies.

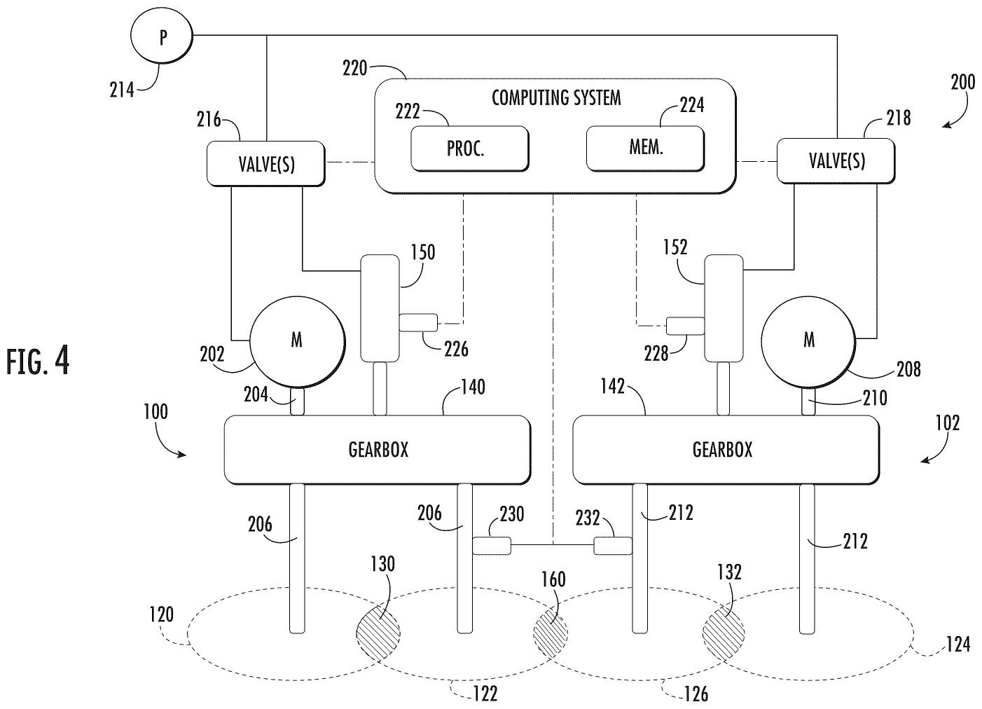

Referring now to FIG. 4, a schematic view of one embodiment of a system 200 for controlling the operation of base cutter assemblies of an agricultural harvester is illustrated in accordance with aspects of the present subject matter. In general, the system 200 will be described with reference to the base cutter assemblies 100, 102 shown and described above with reference to FIGS. 2 and 3. However, it should be appreciated that the system 200 may be advantageously utilized with base cutter assemblies having any other suitable configuration. For purposes of illustration, hydraulic connections are shown in FIG. 4 as solid lines while electrical connections are shown as dash-dot lines. Additionally, for purposes of illustration, the cutter discs 120, 122, 124, 126 of the base cutter assemblies 100, 102 are shown as dashed circles, with the respective cutting zones 130, 132 and the circumferential overlap zone 160 being indicated by cross-hatching.

As shown schematically in FIG. 4, the base cutter assemblies 100, 102 are generally configured as shown and described above with reference to FIGS. 2 and 3. For example, the first base cutter assembly 100 includes a pair of cutter discs (i.e., first inner and outer discs 122, 120), with the blades 128 (FIG. 3) of each disc 120, 122 being configured to circumferentially overlap each other across a first cutting zone 130 defined between the discs 120, 122. Similarly, the second base cutter assembly 102 includes a pair of cutter discs (i.e., second inner and outer discs 126, 124), with the blades 128 (FIG. 3) of each disc 124, 126 being configured to circumferentially overlap each other across a second cutting zone 132 defined between the discs 124, 126. In addition, each base cutter assembly 100, 102 includes a gearbox for mechanically synchronizing the rotation of its respective cutter discs and an actuator for controlling or regulating the vertical height or position of the respective cutter discs. Specifically, the first base cutter assembly 100 includes a first gearbox 140 configured to synchronize the rotation of the first inner and outer discs 122, 120 and a first actuator 150 configured to regulate the vertical height/position of such discs 122, 120. Similarly, the second base cutter assembly 102 includes a second gearbox 142 configured to synchronize the rotation of the second inner and outer discs 126, 124 and a second actuator 152 configured to regulate the vertical height/position of such discs 126, 124.

As shown in FIG. 4, in several embodiments, the cutter discs 120, 122, 124, 126 of each base cutter assembly 100, 102 may be configured to be rotationally driven by a separate drive source, such as a drive motor. Specifically, a first drive motor 202 is coupled to the first gearbox 140 (e.g., via a drive shaft 204) to allow the first drive motor 202 to provide a rotational input for driving the first inner and outer discs 120, 122. The first gearbox 140 may, in turn, be coupled to the first inner and outer discs 122, 120 via respective driven shafts 206 such that the rotational input provided by the first drive motor 202 is transferred to the driven shafts 206 for rotationally driving the first inner and outer discs 122, 120. Similarly, a second drive motor 208 is coupled to the second gearbox 142 (e.g., via a drive shaft 210) to allow the second drive motor 208 to provide a rotational input for driving the second inner and outer discs 126, 124. The second gearbox 142 may, in turn, be coupled to the second inner and outer discs 126, 124 via respective driven shafts 212 such that the rotational input provided by the second drive motor 208 is transferred to the driven shafts 212 for rotationally driving the second inner and outer discs 126, 124. As described above, the gearboxes 140, 142 may be configured to mechanically synchronize the rotation of the counter-rotating inner and outer discs 120, 122, 124, 126 of each respective base cutter assembly 100, 102 such that a circumferential offset is provided between the blades 128 of the inner disc 122, 126 and the blades 128 of the outer disc 120, 124 of the base cutter assembly 100, 102, thereby preventing contact between the blades 127 as they rotate across or through the respective cutting zones 130, 132. For instance, the gearing or geartrain within each gearbox 140m 142 may be configured or selected such that a desired circumferential offsets is maintained between the respective blades 128 of the inner and outer discs 120, 122, 124, 126 as they rotate through their associated cutting zone 130, 132.

In the illustrated embodiment, the first and second drive motors 202, 208 are configured as hydraulic motors. In such an embodiment, as shown in FIG. 4, a source of pressurized hydraulic fluid (e.g., pump 214) may configured to supply hydraulic fluid to the motors 202, 208 for controlling their operation. Additionally, as shown in FIG. 4, the system 200 may include one or more valves 216, 218 fluidly coupled between the pump 214 and the motors 202, 208 to regulate the supply of pressurized hydraulic fluid supplied to each motor 202, 208. For instance, the operation of the valves 216, 218 may be controlled to adjust the output speed of each motor 202, 208 (and, thus, the rotational speed of the associated cutter discs 120, 122, 124, 126). Alternatively, the drive motors 202, 208 may be configured as non-hydraulic motors (e.g., electric motors), in which case the hydraulic-related components (e.g., the pump and valves) may not be necessary.

Additionally, in the illustrated embodiment, the first and second actuators 150, 152 are configured as hydraulic actuators. In such an embodiment, as shown in FIG. 4, a source of pressurized hydraulic fluid (e.g., pump 214) may configured to supply hydraulic fluid to the actuators 150, 152 for controlling their operation. Additionally, as shown in FIG. 4, the system 200 may include one or more valves 216, 218 fluidly coupled between the pump 214 and the actuators 150, 152 to regulate the supply of pressurized hydraulic fluid supplied to each actuator 150, 152. For instance, the operation of each valve 216, 218 may be controlled to adjust the vertical height or position of the cutter discs 120, 122, 124, 126 of the respective base cutter assembly 100, 102, including to allow the associated actuators 150, 152 to be operated within the float mode and the actively controlled mode. Alternatively, the actuators 150, 152 may be configured as non-hydraulic actuators (e.g., electric actuators), in which case the hydraulic-related components (e.g., the pump and valves) may not be necessary.

As shown in FIG. 4, the system 200 may also include a computing system 220 configured to control the operation of the base cutter assemblies 100, 102 (including the operation of any related system components). In general, the computing system 220 may correspond to any suitable processor-based device(s), such as a computing device or any combination of computing devices. Thus, as shown in FIG. 4, the computing system 220 may generally include one or more processor(s) 222 and associated memory devices 224 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 224 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 224 may generally be configured to store information accessible to the processor(s) 222, including data that can be retrieved, manipulated, created and/or stored by the processor(s) 222 and instructions that can be executed by the processor(s) 222.

Moreover, as shown in FIG. 4, the system 200 may include one or more sensors communicatively coupled to the computing system 220 for providing sensor data or feedback related to the operation of the base cutter assemblies 100, 102. For example, in several embodiments, the system 200 may include one or more disc position sensors 226, 228 configured to provide data associated with the vertical height or position of the respective cutter discs 120, 122, 124, 126 of each base cutter assembly 100, 102 (e.g., vertical height/position relative to the ground or relative to another component of the system/harvester). Specifically, as shown in FIG. 4, the system 200 includes a first disc position sensor 226 configured to provide data indicative of the vertical height/position of the cutter discs 120, 122 of the first base cutter assembly 100 and a second disc position sensor 228 configured to provide data indicative of the vertical height/position of the cutter discs 124, 126 of the second base cutter assembly 102. In the illustrated embodiment, the disc position sensors 226, 228 are shown as being provided in operative association with the actuators 150, 152, in which case the sensors 226, 228 may be configured to provide data indicative of the vertical height/position of the cutter discs 120, 122, 124, 126 by monitoring, for example, the stroke distance of the actuators 150, 152 (e.g., by monitoring the relative position of the piston or rod of each respective actuator 150, 152). In other embodiments, the disc position sensors 226, 228 may be provided in operative association with any other suitable component and/or may have any suitable sensor configuration that allows each sensor 226, 228 to provide data indicative of the vertical height/position of the associated cutter discs 120, 122, 124, 126.

Additionally, the system 200 may also include one or more circumferential blade position sensors 230, 232 configured to provide data associated with the circumferential positioning of the blades 128 of the inner cutter discs 122, 126 of the base cutter assemblies 100, 102. Specifically, as shown in FIG. 4, the system 200 includes a first circumferential blade position sensor 230 configured to provide data indicative of the circumferential positioning of the blades 128 of the first inner disc 122 of the first base cutter assembly 100 and a second circumferential blade position sensor 232 configured to provide data indicative of the circumferential positioning of the blades 128 of the second inner disc 126 of the second base cutter assembly 102. For instance, each sensor 230, 232 may provide data indicative of the instantaneous circumferential positions of the blades 128 of the respective inner disc 122, 126, which, as will be described below, may be used to synchronize the rotation of the cutter discs 120, 122, 124, 126 to ensure that a suitable circumferential offset exists between the blades 128 of the inner discs 122, 126 of the base cutter assemblies 100, 102. In the illustrated embodiment, the circumferential blade position sensors 230, 232 are shown as being provided in operative association with the driven shafts 206, 212, in which case the sensors 230, 232 may be configured to provide data indicative of the circumferential positions of the blades 128 by monitoring, for example, the circumferential position of the associated driven shaft 206, 212 (e.g., by configuring each sensor 230, 232 as a rotary encoder or Hall Effect sensor designed to monitor the circumferential position of the driven shaft 206, 212). In other embodiments, the circumferential blade position sensors 230, 232 may be provided in operative association with any other suitable component and/or may have any suitable sensor configuration that allows each sensor 230, 232 to provide data indicative of the circumferential positioning of the blades 128 of the inner cutter discs 122, 126.

It should be appreciated that the computing system 220 may also include a communications interface to provide a means for the computing system 220 to communicate with any of the various system components described herein. For instance, one or more communicative links or interfaces (e.g., one or more data buses) may be provided between the communications interface and the sensors 226, 228, 230, 232 to allow feedback data transmitted from the sensors to be received by the computing system 220. Similarly, one or more communicative links or interfaces (e.g., one or more data buses) may be provided between the communications interface and the various controllable components of the system 200, such as the drive motors 202, 208, the valves 216, 218, the actuators 150, 152, and the like) to allow the computing system 220 to control the operation of such components and, by doing so, control the operation of each base cutter assembly 100, 102.

It should be appreciated that, in one embodiment, the computing system 220 may correspond to a computing system of the associated harvester. For instance, the computing system 220 may correspond to a harvester controller of the associated harvester. However, the computing system 220 may also correspond to a computing system of one or more remote control devices separate from the harvester, such as part of a base station local to the field or part of a cloud-based computing system located remote to the field. Alternatively, the computing system 220 may form all or part of a plug-in module installed relative to the associated harvester to allow for the execution of the disclosed systems and/or methods.

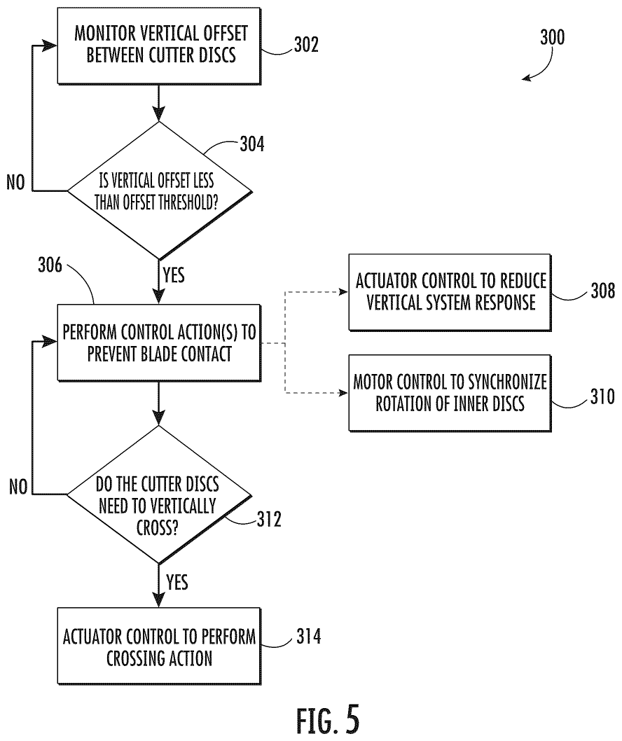

Referring now to FIG. 5, a flow diagram of one embodiment of suitable control logic 300 that may be implemented in association with the disclosed systems and/or methods is illustrated in accordance with aspects of the present subject matter. In general, the control logic 300 will be described herein as being executed by the computing system 220 described above with reference to FIG. 4. However, it should be appreciated that the control logic 300 may generally be implemented by any suitable computing system.

As shown in FIG. 5, at (302), the control logic 300 includes monitoring the vertical offset between the cutter discs 120, 122, 124, 126 of the base cutter assemblies 100, 102, particularly the vertical offset of the inner discs 122, 126 of the base cutter assemblies 100, 102. For example, as indicated above, the computing system 220 may be communicatively coupled to disc position sensors (e.g., first and second disc position sensors 226, 228) configured to provide data indicative of the vertical height/positions of the respective cutter discs 120, 122, 124, 126 of the base cutter assemblies 100, 102. As such, the computing system 220 may be configured to monitor the vertical height/position of the cutter discs 120, 122, 124, 126 of each base cutter assembly 100, 102, which may then be used to calculate or determine a vertical offset defined between the inner cutter discs 122, 126 of the base cutter assemblies 100, 102. In this regard, the vertical offset may generally be indicative of the vertical distance defined between the first inner disc 122 of the first base cutter assembly 100 and the second inner disc 124 of the second base cutter assembly 102.

Additionally, at (304), the control logic 300 may include comparing the vertical offset between the inner discs 122, 126 to a predetermined vertical offset threshold selected for the base cutter assemblies 100, 102. In several embodiments, the vertical offset threshold may correspond to a vertical distance between the inner discs 122, 126 of the base cutter assemblies 100, 102 at which the computing system 220 may need to perform one or more control actions to prevent contact between the blades 128 of the inner discs 122, 126. For example, as shown in FIG. 4, if the vertical offset between the inner discs 122, 126 is not less than the vertical offset threshold, the control logic 300 may simply loop back to (302) without performing any additional control action(s). However, as shown at (306), if the vertical offset between the inner discs 122, 126 is less than the vertical offset threshold, the computing system 220 may be configured to perform one or more control actions adapted to prevent or minimize the risk of contact between the blades 128 of the inner discs 122, 126.

As shown in FIG. 4, the control action performed by the computing system 220 may, in one embodiment, correspond to actuator control adapted reduce the vertical response of the system to changes in the ground profile (e.g., at 308). For instance, as indicated above, the actuator 150, 152 associated with each base cutter assembly 100, 102 may be operated in a float mode in which the actuators 150, 152 allow the base cutter assemblies 100, 102 to track or follow the profile of the ground surface being encountered by the cutter discs 120, 122, 124, 126. In such instance, when the vertical offset between the inner discs 122, 126 is less than the vertical offset threshold, the computing system 220 may be configured to control the operation of the actuators 150, 152 (e.g., via control of the associated valve(s) 216, 218) to dampen or reduce the system's response to changes in the ground profile, such as by controlling the operation of the actuators 150, 152 to reduce the rate at which each base cutter assembly 100, 102 may raise and lower in response to changes in the ground profile. Such a reduction in the system's vertical responsiveness may prevent quick movement of one or both of the base cutter assemblies 100, 102 in a manner that would lead to the vertical position(s) of the cutter discs 120, 122, 124, 126 of the first and second base cutter assemblies 100, 102 being shifted towards the same vertical position, at which point the blades 128 of the inner discs 122, 126 would be at a heightened risk of contacting each other.

In addition to the above-described actuator control (or as an alternative thereto), the control action performed by the computing system 220 may, in one embodiment, correspond to motor control to synchronize the rotation of the inner discs 122, 126 to ensure that a suitable circumferential offset is defined between the circumferential positions of the blades 128 of the first inner disc 122 and the circumferential position of the blades 128 of the second inner disc 126 (e.g., at 310). For example, as indicated above, the computing system 220 may be communicatively coupled to circumferential blade position sensors (e.g., first and second circumferential blade position sensors 230, 232) configured to provide data indicative of the circumferential blade positions of the respective inner discs 122, 126 of the base cutter assemblies 100, 102. As such, the computing system 220 may be configured to monitor the circumferential position of the blades 128 of the inner disc 122, 126 of each base cutter assembly 100, 102, which may then be used as the basis for controlling the operation of one or both of the drive motors 202, 208 (e.g., via control of the operation of the associated valve(s) 216, 218). For instance, assuming that the blades 128 of each inner disc 122, 126 are circumferentially spaced from one another by a given blade-to-blade circumferential spacing (e.g., 60 degrees), the computing system 220 may be configured to control the operation of the drive motors 202, 208 based on the feedback from the circumferential blade position sensors 230, 232 to synchronize the rotation of the cutter discs 120, 122, 124, 126 such that the circumferential offset defined between the blades 128 of the first inner disc 122 and the blades 128 of the second inner disc 126 is equal to half or 50% of the blade-to-blade circumferential spacing (e.g., 30 degrees), thereby maximizing the potential spacing between the blades 128 of the inner discs 122, 126.

It should be appreciated that the computing system 220 may be configured to control the operation of the drive motors 202, 208 in any suitable manner that allows for the desired circumferential offset to be achieved between the blades 128 of the first inner disc 122 and the blades 128 of the second inner disc 126. For instance, in one embodiment, the computing system 220 may be configured temporarily decrease or increase the output speed of one of the drive motors 202, 208 to adjust the relative circumferential positioning of the blades 128 of the inner discs 122, 126. In another embodiment, the computing system 220 may be configured control the operation of both motors 202, 208 to adjust the relative circumferential positioning of the blades 128 of the inner discs 122, 126, such as by temporarily increasing the output speed of one of the drive motors and temporarily decreasing the output speed of the other drive motor.

The above-described control action(s) may generally be utilized by the computing system 220 to prevent or substantially reduce the likelihood of contact between the blades 128 of the inner discs 122, 126. Additionally, while performing such control actions, the computing system 220 may continue to monitor the vertical offset between the cutter discs 120, 122, 124, 126 to determine, at (312), whether the cutter discs need to vertically cross each other (e.g., when the cutter discs 120, 122 of the first base cutter assembly 100 are positioned lower than the cutter discs 124, 126 of the second base cutter assembly 102 and need to shift upwardly to a vertical position above the cutter discs 124, 126 of the second base cutter assembly 102 or vice versa). For instance, in one embodiment, the computing system 220 may continue to monitor the vertical offset between the cutter discs 120, 122, 124, 126 relative to a second vertical offset threshold that is less than the “first” offset threshold used at (304). As an example, the second vertical offset threshold may be equal to 50% of the first offset threshold or 25% of the first offset threshold, or 15% of the first offset threshold or 10% of the first offset threshold. In such instance, if the vertical offset between the cutter discs 120, 122, 124, 126 drops below the lower, second offset threshold, the computing system 220 may infer or determine that the cutter discs 120, 122, 124, 126 need to move vertically across one another.

As shown in FIG. 4, when it is determined that the cutter discs 120, 122, 124, 126 need to vertically cross each other, the computing system 220 may, at (314), be configured to execute suitable actuator control to allow a vertical crossing action to be performed between the base cutter assemblies 100, 102. Specifically, when it is determined that the cutter discs 120, 122, 124, 126 need to vertically cross each other, the computing system 220 may be configured to control the operation of the actuators 150, 152 in opposite directions to effectuate a rapid crossing action during which the cutter discs 120, 122, 124, 126 of the base cutter assemblies 100, 102 quickly switch vertical positions to minimize the amount of time that the blades 128 of the inner discs 122, 126 are simultaneously within the circumferential overlap zone 160. For instance, if the cutter discs 120, 122 of the first base cutter assembly 100 are positioned above than the cutter discs 124, 126 of the second base cutter assembly 102 and need to shift downwardly to a vertical position below the cutter discs 124, 126 of the second base cutter assembly 102, the computing system 220 may be configured to control the operation of the first actuator 150 to rapidly lower the first base cutter assembly 100 while simultaneously controlling the operation of the second actuator 152 to rapidly raise the second base cutter assembly 102. In doing so, the actuators 150, 152 may be controlled so that the inner cutter discs 122, 126 of the base cutter assemblies 100, 102 are moved quickly past another until a suitable vertical offset is again achieved between the cutter discs. For instance, in one embodiment, when performing the vertical crossing action, the computing system 220 may be configured to control the actuators such that the cutter discs 122, 126 are actuated vertically past one another to a vertical offset that is equal to or greater than the second vertical offset threshold.

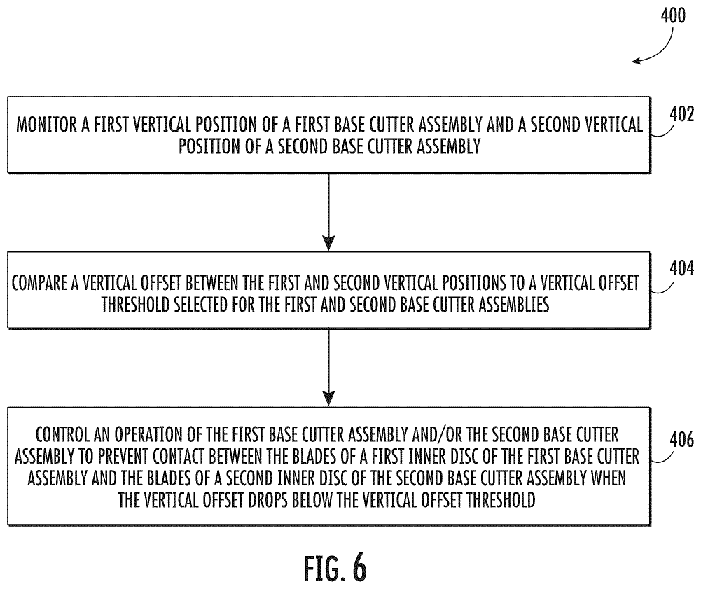

Referring now to FIG. 6, a flow diagram of one embodiment of a method 400 for controlling base cutter operation for an agricultural harvester is illustrated in accordance with aspects of the present subject matter. In general, the method 400 will be described herein with reference to the system 200 described with reference to FIG. 4. However, it should be appreciated that the disclosed method 400 may be implemented with systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (402), the method 400 may include monitoring a first vertical position of a first base cutter assembly and a second vertical position of a second base cutter assembly. For instance, as indicated above, the computing system 220 may be communicatively coupled to disc position sensors 226, 228 configured to provide data indicative of the vertical height/position of the base cutter assemblies 100, 102 (and, thus, the vertical heights/positions of the respective cutter discs 120, 122, 124, 126 of the base cutter assemblies 100, 102). As such, based on the data received from the sensors 226, 228, the computing system 220 may be configured to monitor first and second vertical positions associated with the first and second base cutter assemblies 100, 102, respectively.

Additionally, at (404), the method 400 may include comparing a vertical offset between the first and second vertical positions to a vertical offset threshold selected for the first and second base cutter assemblies. Specifically, as indicated above, the computing system 220 may be configured to calculate a vertical offset between the cutter discs 120, 122 of the first base cutter assembly 100 and the cutter discs 124, 126 of the second base cutter assembly 102 based on the vertical positions determined as a function of the sensor feedback provided by the sensors 226, 228. The computing system 220 may then compare the vertical offset to a predetermined vertical offset threshold selected for the base cutter assemblies 100, 102.

Moreover, at (406), the method 400 may include controlling an operation of at least one of the first base cutter assembly or the second base cutter assembly to prevent contact between a plurality of blades of a first inner disc of the first base cutter assembly and a plurality of blades of a second inner disc of the second base cutter assembly when the vertical offset drops below the vertical offset threshold. For example, as indicated above, the computing system 220 may be configured to perform one or more control actions when the monitored vertical offset drops below the associated offset threshold, such as by performing actuator control to reduce the system's overall vertical responsiveness, by performing motor control to synchronize the rotation of the cutter discs 120, 122, 124, 126 to ensure that a circumferential offset exists between the blades 128 of the inner discs 122, 126, and/or by performing actuator control to perform a rapid vertical crossing action when it is determined that the cutter discs need to vertically cross one another.

It is to be understood that the steps of the method 400 are performed by the computing system 220 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 220 described herein, such as the method 400, is implemented in software code or instructions which are tangibly stored on a tangible computer readable medium. The computing system 220 loads the software code or instructions via a direct interface with the computer readable medium or via a wired and/or wireless network. Upon loading and executing such software code or instructions by the computing system 220, the computing system 220 may perform any of the functionality of the computing system 220 described herein, including any steps of the method 400 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for controlling base cutter operation for an agricultural harvester, the agricultural system comprising:
a first base cutter assembly comprising a first pair of cutter discs, the first pair of cutter discs including a first inner disc and a first outer disc, each of the first inner and outer discs including a plurality of blades spaced apart circumferentially around its outer perimeter;
a second base cutter assembly comprising a second pair of cutter discs, the second pair of cutter discs including a second inner disc and a second outer disc, each of the second inner and outer discs including a plurality of blades spaced apart circumferentially around its outer perimeter,
wherein the first and second base cutter assemblies are movable relative to each other in a vertical direction; and
wherein the first and second inner discs are positioned relative to each other in a lateral direction such that the plurality of blades of the first inner disc circumferentially overlap with the plurality of blades of the second inner disc when the first and second inner discs are disposed at a common vertical position;
a computing system configured to control an operation of the first and second base cutter assemblies to prevent contact between the plurality of blades of the first inner disc and the plurality of blades of the second inner disc as the first and second base cutter assembles are moved relative to each other in the vertical direction.

2. The agricultural system of claim 1, wherein the computing system is configured to:
monitor a first vertical position of the first base cutter assembly and a second vertical position of the second base cutter assembly; and
compare a vertical offset between the first and second vertical positions to a vertical offset threshold selected for the first and second base cutter assemblies.

3. The agricultural system of claim 2, wherein the computing system is configured to control the operation of at least one of the first base cutter assembly or the second base cutter assembly to prevent contact between the plurality of blades of the first inner disc and the plurality of blades of the second inner disc when the vertical offset drops below the vertical offset threshold.

4. The agricultural system of claim 1, further comprising a first drive motor configured to rotationally drive the first pair of cutter discs of the first base cutter assembly and a second drive motor configured to rotationally drive the second pair of cutter discs of the second base cutter assembly, the computing system being configured to control an operation of the first and second drive motors such that a circumferential offset exists between the plurality of blades of the first inner disc and the plurality of blades of the second inner discs.

5. The agricultural system of claim 4, wherein the computing system is configured to monitor a first circumferential blade position of the plurality of blades of the first inner disc and a second circumferential blade position of the plurality of blades of the second inner disc, the computing system being configured to control the operation of the first and second drive motors based on the monitored first and second circumferential blade positions.

6. The agricultural system of claim 4, wherein the first drive motor rotationally drives the first pair of cutter discs via a first gearbox such that a circumferential offset exists between the plurality of blades of the first inner disc and the plurality of blades of the first outer disc, wherein the second drive motor rotationally drives the second pair of cutter discs via a second gearbox such that a circumferential offset exists between the plurality of blades of the second inner disc and the plurality of blades of the second outer disc.

7. The agricultural system of claim 1, wherein the first base cutter assembly includes a first actuator configured to adjust a first vertical position of the first base cutter assembly and the second base cutter assembly includes a second actuator configured to adjust a second vertical position of the second base cutter assembly, the controller being configured to control an operation of the first and second actuators.

8. The agricultural system of claim 7, wherein the computing system is configured to reduce a vertical responsiveness of the first and second actuators when a vertical offset between the first and second vertical positions drops below a vertical offset threshold selected for the first and second base cutter assemblies.

9. The agricultural system of claim 7, wherein the computing system is configured to control the operation of the first and second actuators to actuate the first and second base cutter assemblies in opposite directions when it is determined that the first and second pairs of cutter discs need to vertically cross each other.

10. The agricultural system of claim 9, wherein the computing system is configured to determine that the first and second pairs of cutter discs need to vertically cross each other when a vertical offset between the first and second vertical positions drops below a vertical offset threshold selected for the first and second base cutter assemblies.

11. A method for controlling base cutter operation for an agricultural harvester, the agricultural harvester including a first base cutter assembly and a second base cutter assembly, the method comprising:
monitoring, with a computing system, a first vertical position of the first base cutter assembly and a second vertical position of the second base cutter assembly, the first base cutter assembly comprising a pair of cutter discs including a first inner disc and a first outer disc, the second base cutter assembly comprising a second pair of cutter discs including a second inner disc and a second outer disc;
comparing, with the computing system, a vertical offset between the first and second vertical positions to a vertical offset threshold selected for the first and second base cutter assemblies; and
when the vertical offset drops below the vertical offset threshold, controlling, with the computing system, an operation of at least one of the first base cutter assembly or the second base cutter assembly to prevent contact between a plurality of blades of the first inner disc of the first base cutter assembly and a plurality of blades of the second inner disc of the second base cutter assembly;
wherein the first and second inner discs are positioned relative to each other in a lateral direction such that plurality of blades of the first inner disc circumferentially overlap with the plurality of blades of the second inner disc when the first and second inner discs are disposed at a common vertical position.

12. The method of claim 11, wherein the agricultural harvester includes a first drive motor configured to rotationally drive the first pair of cutter discs of the first base cutter assembly and a second drive motor configured to rotationally drive the second pair of cutter discs of the second base cutter assembly, wherein controlling the operation of the at least one of the first base cutter assembly or the second base cutter assembly comprise controlling an operation of at least one of the first drive motor or the second drive motor such that a circumferential offset exists between the plurality of blades of the first inner disc and the plurality of blades of the second inner discs.

13. The method of claim 12, further comprising monitoring a first circumferential blade position of the plurality of blades of the first inner disc and a second circumferential blade position of the plurality of blades of the second inner disc, wherein controlling the operation of the at least one of the first drive motor or the second drive motor comprises controlling the operation of the at least one of the first drive motor or the second drive motor based on the monitored first and second circumferential blade positions.

14. The method of claim 12, wherein the first drive motor rotationally drives the first pair of cutter discs via a first gearbox such that a circumferential offset exists between the plurality of blades of the first inner disc and the plurality of blades of the first outer disc, wherein the second drive motor rotationally drives the second pair of cutter discs via a second gearbox such that a circumferential offset exists between the plurality of blades of the second inner disc and the plurality of blades of the second outer disc.

15. The method of claim 11, wherein the first base cutter assembly includes a first actuator configured to adjust the first vertical position of the first base cutter assembly and the second base cutter assembly includes a second actuator configured to adjust the second vertical position of the second base cutter assembly.

16. The method of claim 15, wherein controlling the operation of the at least one of the first base cutter assembly or the second base cutter assembly comprise controlling an operation of at least one of the first actuator or the second actuator to reduce a vertical responsiveness of the first and second actuators when the vertical offset between the first and second vertical positions drops below the vertical offset threshold.

17. The method of claim 15, wherein controlling the operation of the at least one of the first base cutter assembly or the second base cutter assembly comprise controlling an operation of the first and second actuators to actuate the first and second base cutter assemblies in opposite directions when it is determined that the first and second pairs of cutter discs need to vertically cross each other.

18. The method of claim 18, wherein the vertical offset threshold comprises a first vertical offset threshold, further comprising determining that the first and second pairs of cutter discs need to vertically cross each other when the vertical offset between the first and second vertical positions drops below a second vertical offset threshold that is less than the first vertical offset threshold.
